(19) United States
(12) Patent Application Publication
(10) Pub. No.: US 2017/0286252 A1
(43) Pub. Date: Oct. 5, 2017

(54) Workload Behavior Modeling and Prediction for Data Center Adaptation

(71) Applicant: Intel Corporation, Santa Clara, CA (US)

(72) Inventors: RAMESHKUMAR G. ILLIKKAL, Folsom, CA (US); SAJAN K. GOVINDAN, Folsom, CA (US); DEEPTHI KARKADA, Charlotte, NC (US); SANDEEP PAL, Folsom, CA (US); PATRICK J. HOLMES, El Dorado Hills, CA (US)

(21) Appl. No.: 15/089,378

(22) Filed: Apr. 1, 2016

(51) Int. Cl. G06F 11/34; H04L 12/917

(52) U.S. Cl. CPC G06F 11/3457; H04L 47/76

(57) ABSTRACT

Examples may include techniques to a indicate behavior of a data center. A data center is monitored to collect operating information and one or more models to represent behavior of the data center are built based on the collected operating information. Predicted behavior of the data center to support a workload based on different operating scenarios using the one or more built models is indicated to facilitate resource allocation and scheduling for the workload supported by the data center.

### BACKGROUND

Technological advancements in networking have enabled the rise in use of pooled and/or configurable computing resources. These pooled and/or configurable computing resources may include physical infrastructure for large data centers that may support cloud computing networks. The physical infrastructure may include one or more computing systems having processors, memory, storage, networking, power, cooling, etc. Additionally, other layers supporting a data center may include big data frameworks such as the free and open-source Apache Spark™ framework as well as big data software and applications supported by big data frameworks. Management entities at the various levels of these data centers may provision computing resources to virtual computing entities such as virtual machines (VMs) to allocate portions of pooled and/or configurable computing resources in order to place or compose these VMs to support, implement, execute or run a workload. Different or separate workloads may be supported by this type of allocated and layered infrastructure in a shared manner.

### BRIEF DESCRIPTION OF THE DRAWINGS

FIG. 1 illustrates an example data center.

FIG. 2 illustrates an example first scheme.

FIG. 3 illustrates an example second scheme.

FIG. 4 illustrates an example third scheme.

FIG. 5 illustrates an example block diagram for an apparatus.

FIG. 6 illustrates an example third flow.

FIG. 7 illustrates an example of a storage medium.

FIG. 8 illustrates an example computing platform.

### DETAILED DESCRIPTION

Data centers may be composed of an infrastructure layer that includes a large number racks that may contain or house numerous types of hardware or configurable computing resources (e.g., storage, central processing units (CPUs), memory, networking, fans/cooling modules, power units, etc.). The types of hardware or configurable computing resources deployed in data centers may also be referred to as disaggregate physical elements. The size and number of computing resources and the continual disaggregation of these resources presents practically countless combinations of computing resources that can be configured to fulfill workloads. Also, types of workloads may have different characteristics that may require a different mix of computing resources to efficiently fulfill a give type of workload.

Today's computer architecture community (industry and academic) has a predominate focus on hardware and software architecture analysis and optimization at a single node level (e.g., a single server). For a workload being supported by a big data type framework having disaggregated computing resources, a goal may be not only optimization of individual nodes, but also optimization of an overall end-to-end performance, power, thermal and/or total cost of ownership (TCO) at all levels of a data center. The above-mentioned practically countless combinations of computing resources and allocation options to support workloads in a typical distributed environment may make it difficult for configuration management, scheduling or resource orchestration/management entities of a data center to optimize end-to-end performance, power, thermal and/or TCO at all levels of the data center. It is with respect to these and/or other challenges that the examples described herein are needed.

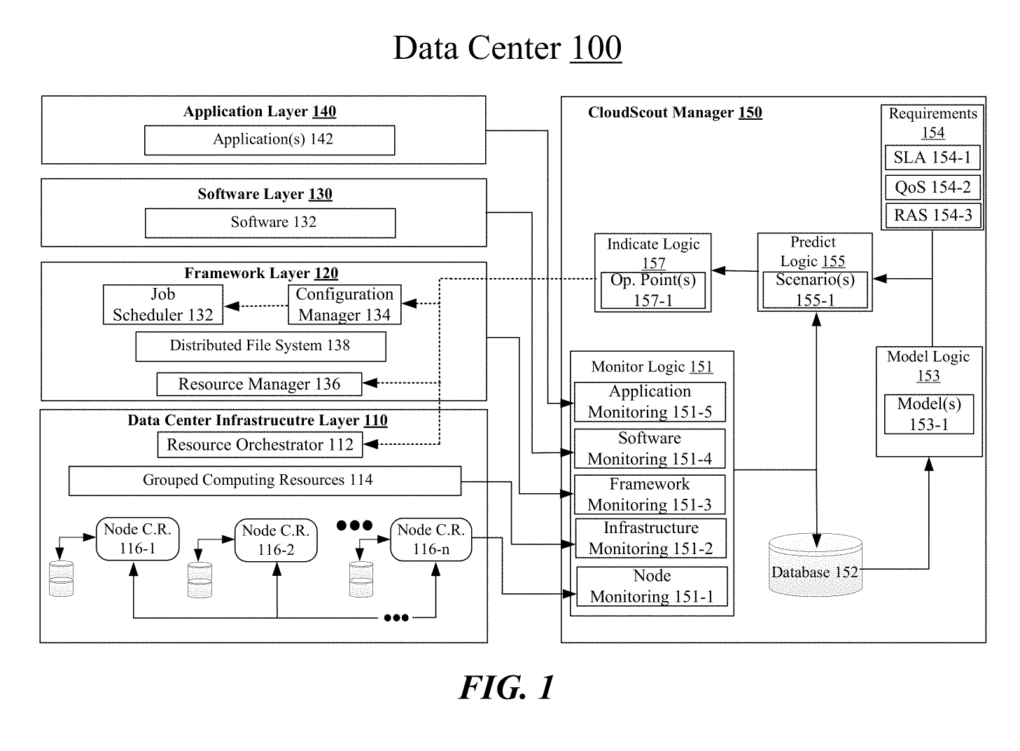

FIG. 1 illustrates an example data center 100. As shown in FIG. 1, data center 100 includes a data center infrastructure layer 110, a framework layer 120, a software layer 130 and an application layer 140. Also, as shown in FIG. 1, data center 100 includes a CloudScout manager 150. As described more below, CloudScout manager 150 may include logic and/or features to monitor the various layers of data center 100 to collect operating information and build one or more models using the collected operating information to represent behavior of data center 100 while supporting at least one workload. Logic and/or features of CloudScout manager 150 may also be capable of predicting behavior of data center 100 to support a workload based on different operating scenarios that may include input of different operating or configuration parameters in the one or more built models. Logic and/or features of CloudScout manager 150 may then indicate results of predicted behavior to facilitate resource allocation and scheduling for the workload that may be supported by data center 100.

According to some examples, as shown in FIG. 1, data center infrastructure layer 110 may include a resources orchestrator 112, grouped computing resources 114 and node computing resources (C.R.s) 116-1 to 116-n, where “n” represents any whole, positive integer>2. Computing resources included with node C.R.s 116-1 to 116-n may include, but are not limited to one or more of a central processing unit (CPU) or processor, a memory device, a storage device, a network input/output (NW I/O) device, a NW switch, a virtual machine (VMs), a power module or a cooling module. In some examples, a given node C.R. from among node C.R.s 116-1 to 116-n may be a server having one or more of the above-mentioned computing resources.

In some examples, grouped computing resources 114 may include separate groupings of node C.R.s housed within one or more racks (not shown), or many racks housed in data centers at various geographical locations (also not shown). The separate groupings of node C.R.s may represent grouped compute, network, memory or storage resources that may be configured or allocated to support one or more workloads. For example, several node C.R.s including CPUs or processors may grouped within one or more racks to provide compute resources to support the one or more workloads. These one or more racks may also include power modules, cooling modules or NW switches.

According to some examples, resource orchestrator 122 may be arranged to compose either individual node C.R.s 116-1 to 116-n or grouped computing resources 114. In some examples, resource orchestrator 122 may be a type of software design infrastructure (SDI) management entity for data center 100.

In some examples, as shown in FIG. 1, framework layer 120 includes a job scheduler 132, a configuration manager 134, a resource manager 136 and a distributed file system 138. In some examples, framework layer 120 may represent a framework to support software 132 of software layer 130 and/or one or more application(s) 142 of application layer 140. Software 132 or application(s) 142 may respectively include web-based software or applications. Framework layer 120 may be, but is not limited to, a type of free and open-source software web application framework such as Apache Spark™ (hereinafter “Spark”) that may utilize distributed file system 138 for large-scale data processing (e.g., “big data”). Also, job scheduler 132 may be arranged as a type of Spark Driver to facilitate scheduling of workloads supported by the various layers of data center 100. Configuration manager 134 may be capable of configuring different layers such as software layer 130 and framework layer 120 including Spark and distributed file system 138 for supporting the large-scale data processing. Meanwhile, resource manager 136 may be capable of managing clustered or grouped computing resources mapped to or allocated for support of distributed file system 138 and job scheduler 132. The clustered or grouped computing resources may include grouped computing resource 114 at data center infrastructure layer 110. Resource manager 136 may coordinate with resource orchestrator 112 to manage these mapped or allocated computing resources.

According to some examples, software 132 included in software layer 130 may include one or more types of software implemented by at least portions of node C.R.s 116-1 to 116-n, grouped computing resources 114 or distributed file system 138 of framework layer 120. The one or more types of software may include, but are not limited to, Internet web page search software, e-mail virus scan software, database software or streaming video content software.

According to some examples, application(s) 142 included in application layer 140 may include one or more types of applications implemented by at least portions of node C.R.s 116-1 to 116-n, grouped computing resources 114 or distributed file system 138 of framework layer 120. The one or more types of applications may include, but are not limited to, a genomics application, a cognitive compute or a machine learning application.

According to some examples, as shown in FIG. 1, CloudScout manager 150 includes a monitor logic 151, a database 152, a model logic 153, requirements 154, a predict logic 155 or an indicate logic 157. As briefly mentioned above, CloudScout manager 150 includes logic and/or features to monitor and collect operating information for data center 100, build models, predict behavior and indicate predicted behavior to facilitate resource allocation and scheduling for a workload that may be supported by data center 100. For example, monitor logic 151 may include node monitoring 151-1 to monitor node C.R.s 116-1, 116-2 or 116-n to collect operating information. Collected operating information may include margin to maximum designed or pre-determined operating specifications for these C.R.s (e.g., maximum utilization capacities or peak operating temperature thresholds). Collected operating information may also include throttling activation information for such computing resources as CPUs/processors, memory, NW I/O devices, NW switches, VMs, power modules or cooling modules. The throttling activation information may indicate if and for how long throttling was activated over a given time period. For example, responsive to utilization capacities or peak operating temperature thresholds being exceeded over a given time period. Examples are not limited to the above-mentioned collected operating information for node C.R.s.

In some examples, as shown in FIG. 1, monitor logic 151 may also include infrastructure monitoring 151-2. Infrastructure monitoring 151-2 may include monitoring grouped computing resources 114 (e.g., housed in racks). For example, inlet/outlet temperatures for one or more rack housings, power consumption for one or more rack housings, fan speed for a cooling module for one or more rack housings, derived volumetric airflow for one or more rack housings. Collected operating information may also include networking and/or storage bandwidth latencies, up/downtime statistics or application/software installations/sharing. Examples are not limited to the above-mentioned collected operating information for grouped computing resources 114. In some scenarios, the infrastructure monitoring may include monitoring multiple racks in a data center and multiple data centers distributed across multiple geographies (not shown).

According to some examples, as shown in FIG. 1, monitor logic 151 may also include framework monitoring 151-3. Framework monitoring 151-3 may monitor operating information such as detailed trace information for supporting one or more workloads. For example, in a Spark framework, detailed traces of Spark events may be collected via a standardized format.

In some examples, as shown in FIG. 1, monitor logic 151 may also include software monitoring 151-4 as wells as application monitoring 151-5 to monitor operating information from software 132 and application(s) 142, respectively. For these examples, software 132 or application(s) 142 may be profiled to obtain software/application level information. For example, operating information such as data size, number of data partitions or processor affinity may be added to metadata that may be accessible to software monitoring 151-4 or application monitoring 151-5 in order to collect this software/application level information.

According to some examples, operating information monitored by node monitoring 151-1, infrastructure 151-2, framework monitoring 151-3, software monitoring 151-4 or application monitoring 151-5 may be collected and at least temporarily stored in database 152. In some examples, model logic 153 may build one or more model(s) 153-1 using the collected operating information stored in database 152. For example, analytical and simulation models to represent a given workload supported by data center 100 may be built and included in model(s) 153-1 with the operating information collected. These analytical models may extend a traditional cycles per instruction model typically used in some model building methods for servers by also modeling such operating behaviors as networking and storage latencies or queuing delays. Behavioral simulation models such as Intel® Corporations Cofluent™ studio may be utilized to increase projection accuracy especially in case of workloads with multiple dynamic phases. As described more below, machine learning techniques may be utilized to establish workload profiles or types based on historical monitoring data from database 152 in order to build one or more model(s) 153-1 for prediction or to classify the given workload for which behavior may be predicted using one or more model(s) 153-1.

In some examples, requirements 154 may include predefined rules or polices associated with service level agreement (SLA) 154-1, quality of service (QoS) 154-2, or reliability, availability and serviceability (RAS) 154-3 requirements. These types of predefined rules or policies may be used to establish different operating scenarios for which predicted behavior of data center 100 may be determined while supporting the given workload. For example, scenario(s) 155-1 may include operating or configuration parameters to meet requirements 154. Predict logic 155 may use operating or configuration parameters suggested by scenario(s) 155-1 as inputs to model(s) 153-1 built by model logic 153. Also, indicate logic 157 may determine various “whatif” insights regarding scenario(s) 155-1 that includes use of one or more operating point(s) 157-1 to indicate results of predicted behavior including at least one of an indication of performance characteristics, an indication of thermal characteristics, power characteristics or reliability characteristics for operating points 157-1. Indicate logic 157 may use the whatif posed by operating point(s) 157-1to modify the operating or configuration parameters suggested by scenarios(s) 155-1 in order to further refine predicted behavior and yet still meet requirements 154. For example, indicate logic 157 may determine benefits/costs of scaling node C.R.s 116-1 to 116-n to support the given workload and then indicate or suggest an optimal number of node C.R.s after which scaling benefits may be minimum or detrimental to meeting requirements 154.

According to some examples, indicate logic 157 may be capable of indicating results of predicted behavior to job scheduler 132, configuration manger 134, resource manager 136 or resource orchestrator 112 to facilitate resource allocation and scheduling for the given workload supported by data center 100. For these examples, as shown in FIG. 1, the dotted-lines represent a movement of these indicated results to job scheduler 132, configuration manger 134, resource manager 136 or resource orchestrator 112. As described more below, in some examples, enforcement actions may be taken by job scheduler 132, configuration manger 134, resource manager 136 or resource orchestrator 112 to implement self-modifying actions that may relieve a data center operator of data center 100 from making possibly bad configuration decisions and possibly avoiding underutilized and/or poor performing portions of a data center.

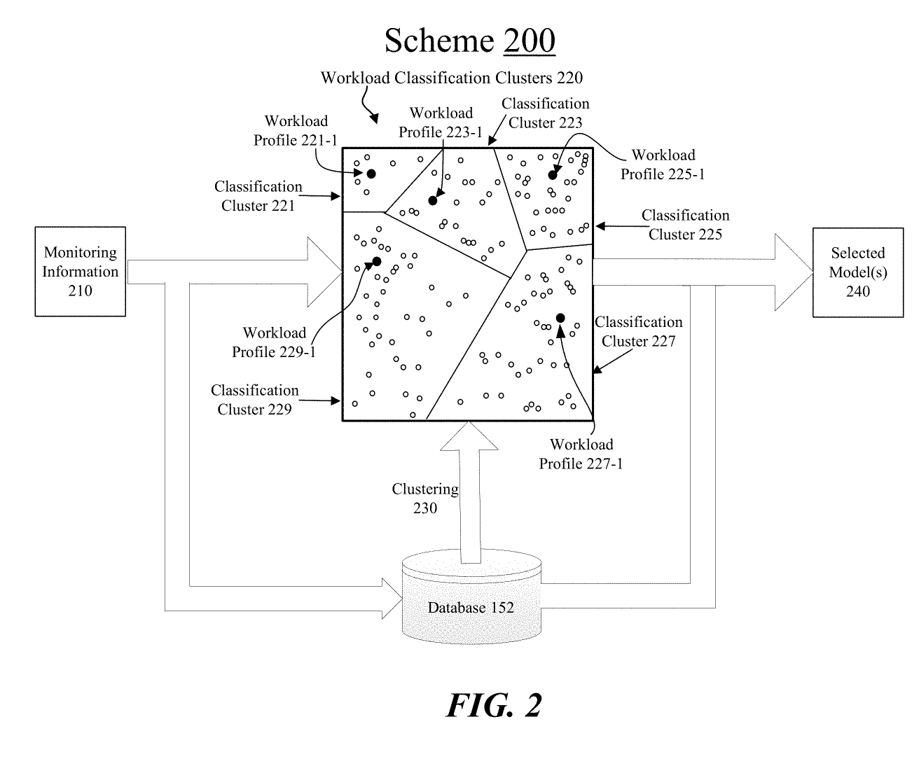

FIG. 2 illustrates an example scheme 200. In some examples, scheme 200 may be implemented by elements of system 100 as shown in FIG. 1 such as logic and/or features of CloudScout manager 150. Although scheme 200 is not limited to elements included in system 100.

In some examples, as shown in FIG. 2, scheme 200 may include monitoring operating information 210. For these examples, monitoring operating information 210 may include monitored information related to a workload being supported by data center 100. Operating information 210 may be added with operating information previously collected and at least temporarily stored in database 152. Clustering 230 as shown in FIG. 2 may represent employment of machine learning techniques in order to establish and continually maintain workload classification clusters 220 using collected operating information. According to some examples, these machine learning techniques may include, but are not limited to, application of k-means clustering or neural network based classifications to generate or determine workload classification clusters 220.

According to some examples, classification clusters 221, 223, 225, 227 or 229 may be five example workload classification clusters generated or determined via clustering 230. For these examples, at least one workload profile may be established in each classification cluster 221, 223, 225, 227 or 229. Each workload profile may have required different configurations of data center resources to support. For examples, a first workload profile such as workload profile 221-1 included in classification cluster 221 may be processing or CPU intensive. A second workload profile such as workload profile 223-1 may be memory intensive. A third workload profile such as workload profile 225-1 may be network switch intensive. A fourth workload profile such as workload profile 227-1 may be storage intensive. A fifth workload profile such as workload profile 229-1 may have a balanced profile that has relatively equal CPU, memory, network switch and storage intensities.

In some examples, in addition to collecting monitoring information 210 in database 152, at least some of monitoring information 210 related to the workload being supported by data center 100 may be used to classify the workload using workload classification clusters 220. A determination may then be made based on the monitoring information 210 as to what workload profile the workload may have. For example, monitoring information 210 may indicate that the workload has a workload profile approximate to workload profile 227-1 that may be a storage intensive workload profile. Workload classification 240 may then indicate the storage intensive workload profile and selected model(s) 250 may be selected by logic and/or features of CloudScout 150 (e.g., predict logic 155) to predict behavior of data center 100 to support the workload based on workload classification 240.

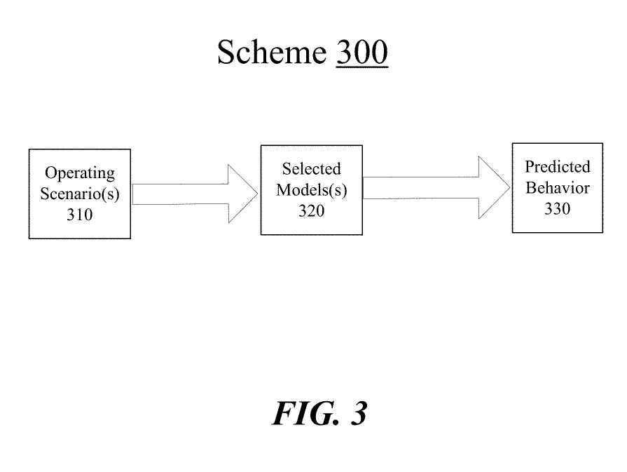

FIG. 3 illustrates an example scheme 300. In some examples, scheme 300 may be implemented by elements of system 100 as shown in FIG. 1 such as logic and/or features of CloudScout manager 150. Although scheme 300 is not limited to elements included in system 100.

In some examples, as shown in FIG. 3, scheme 300 may include operating scenario(s) 310. As mentioned previously, predefined rules or policies such as those included in QoS, SLA or RAS requirements may be used to establish different operating scenarios for which predicted behavior of data center 100 may be determined while supporting a workload. As shown in FIG. 3, selected model(s) 320 may include one or more models selected in a similar manner as described for scheme 200 in FIG. 2. A predicted behavior 330 may then be determined using selected model(s) 320 based on operating scenario(s) 310 that includes input of different operating or configuration parameters to selected model(s) 320.

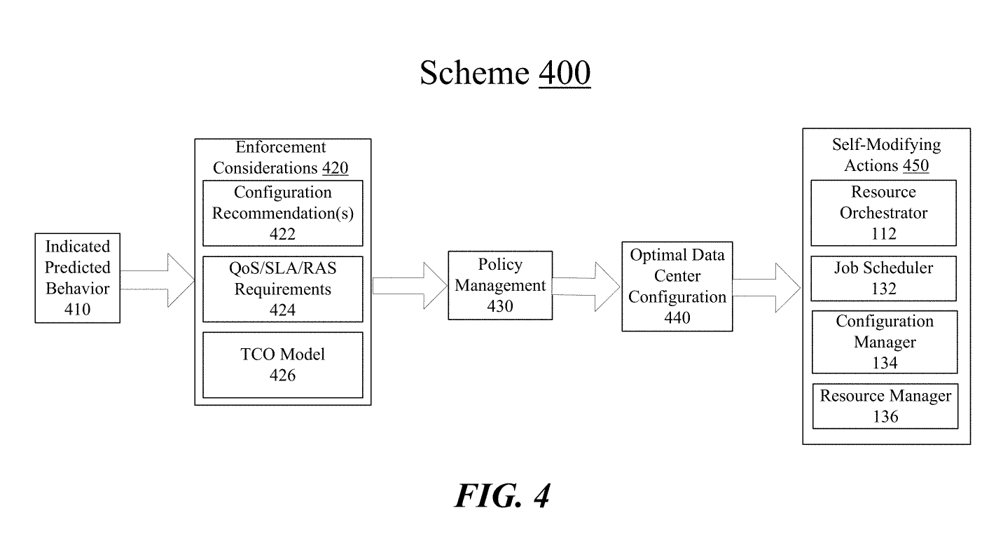

FIG. 4 illustrates an example scheme 400. In some examples, scheme 400 may be implemented by elements of system 100 as shown in FIG. 1 such as logic and/or features of CloudScout manager 150. Although scheme 400 is not limited to elements included in system 100.

In some examples, as shown in FIG. 4, scheme 400 may include indicated predicted behavior 410. Indicated predicted behavior 410 may include predicted behavior based on models selected in a similar manner as described for scheme 200 shown in FIG. 2 and determined using different operating scenarios and one or more selected models as described for scheme 300 shown in FIG. 3. The predicted behavior may indicate an indication of performance characteristics, thermal characteristics, power characteristics or reliability characteristics derived from various operating points from different operating scenarios for data center 100.

According to some examples, enforcement considerations 420 may include one or more configuration recommendation(s) 422, QoS/SLA/RAS requirements 424 and a total cost of ownership (TCO) model 426. For these examples, configuration recommendation(s) 422 may include configuration recommendations that may be established or provided by vendors, designers or manufactures of the various computing resources included in data center 100. For example, minimum or recommended compute, memory, storage or NW I/O to implement software and/or applications to support a workload. QoS/SLA/RAS requirements 424 may indicate that even though indicated predicted behavior 410 may account for these requirements, enforcement considerations 420 still need to assess whether changes to the configuration data center 100 will cause one or more of these requirements to not be met. TCO model 426 may be used to ensure that configuration changes are affordable or cost effective given those configuration changes. For example, TCO model 426 may indicate how much customers of services provided by data center 100 may value (e.g., pay for) possible performance gains associated with configuration changes vs. how much those configuration changes may cost to both add to and/or maintain reconfigured computing resources within data center 100.

In some examples, policy management 430 may indicate policies that may be managed in following enforcement considerations 420. Policy management 430 may include a relative weighting of configuration recommendation(s) 422, QoS requirements 424 or TCO model 426 to arrive at an optimal data center configuration 440. Self-modifying actions 450 may include actions by resource orchestrator 112, job scheduler 132, configuration manger 134 and/or resource manager 136 to make use of optimal data center configuration 440 to configure respective layers of data center 100. Thus, indicated predicted behavior 410 may facilitate resource allocation and scheduling for workloads supported by data center 100.

According to some examples, enforcement considerations 420, policy management 430 or optimal data center configuration 440 may be implemented by logic and/or features of CloudScout 150 (e.g., via indication logic 157). In other examples, at least one of enforcement considerations 420, policy management 430 or optimal data center configuration 440 may be included in other management entities for data center 100.

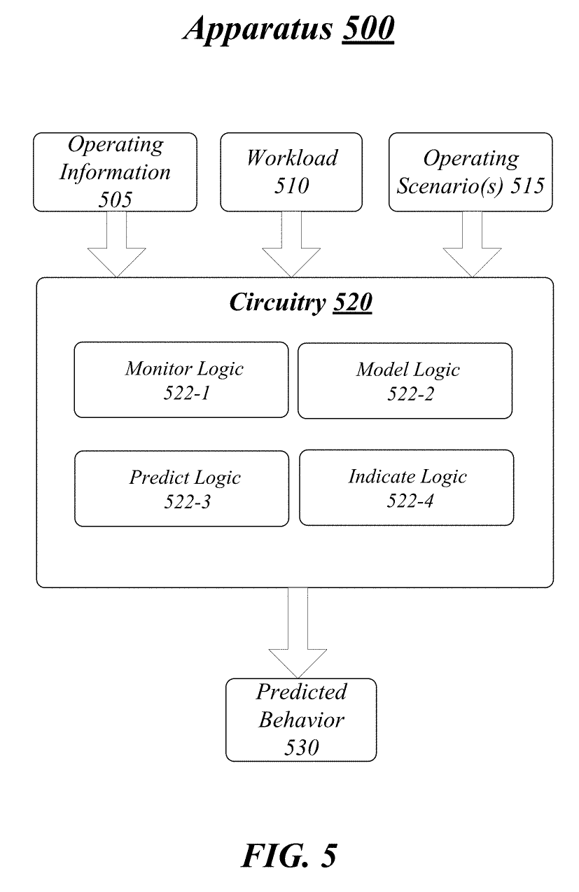

FIG. 5 illustrates an example block diagram for an apparatus 500. Although apparatus 500 shown in FIG. 5 has a limited number of elements in a certain topology, it may be appreciated that the apparatus 500 may include more or less elements in alternate topologies as desired for a given implementation.

The apparatus 500 may be supported by circuitry 520 maintained at a computing device including logic or features to support or facilitate configuring of configurable computing resources for a data center (e.g. CloudScout 150). Circuitry 520 may be arranged to execute one or more software or firmware implemented modules, components or logic 522-a. It is worthy to note that “a” and “b” and “c” and similar designators as used herein are intended to be variables representing any positive integer. Thus, for example, if an implementation sets a value for a=4, then a complete set of software or firmware for modules, components or logic 522-a may include logic 522-1, 522-2, 522-3 or 522-4. The examples presented are not limited in this context and the different variables used throughout may represent the same or different integer values.

According to some examples, circuitry 520 may include a processor, processor circuit or processor circuitry. Circuitry 520 may be part of computing device circuitry that includes processing cores (e.g., used as a central processing unit (CPU)). The circuitry including one or more processing cores can be any of various commercially available processors, including without limitation an AMD® Athlon®, Duron® and Opteron® processors; ARM® application, embedded and secure processors; Qualcomm® Snapdragon, IBM®, Motorola® DragonBall®, Nvidia®Tegra® and PowerPC® processors; IBM and Sony® Cell processors; Intel® Celeron®, Core (2) Duo®, Core i3, Core i5, Core i7, Itanium®, Pentium®, Xeon®, Atom®, and XScale® processors; and similar processors. Dual microprocessors, multi-core processors, and other multi-processor architectures may also be employed as part of circuitry 520. According to some examples circuitry 520 may also be an application specific integrated circuit (ASIC) and at least some components, modules or logic 522-a may be implemented as hardware elements of the ASIC.

According to some examples, apparatus 500 may include a monitor logic 522-1. Monitor logic 522-1 may be executed by circuitry 520 to monitor a data center to collect operating information. For these examples, operating information 505 may include the operating information collected from the data center during monitoring by monitor logic 522-1.

According to some examples, apparatus 500 may also include a model logic 522-2. Model logic 522-2 may be executed by circuitry 520 to build one or more models to represent behavior of the data center using the collected operating information while the data center supports at least one workload. Model logic 522-2 may also be capable of determining a workload classification cluster via machine learning that includes application of k-means clustering to collected operating information to determine the workload classification cluster.

In some examples, apparatus 500 may also include a predict logic 522-3. Predict logic 522-3 may be executed by circuitry 520 to predict behavior of the data center to support a workload based on different operating scenarios that includes input of different operating or configuration parameters in the one or more built models. For these examples, the different operating scenarios may be included in operating scenario(s) 515 for a workload indicated by workload 510. Predict logic 522-3 may also be capable of classifying the workload based on the workload having a workload profile or type that falls within the workload classification cluster determined by model logic 522-2 and then selecting at least one of the one or more built models to predict behavior of the data center to support the workload based on the classifying of the workload. The classified workload may have a workload profile that may be processing or CPU intensive, memory intensive, network switch intensive, storage intensive or a balance of each of these various workload profiles.

According to some examples, apparatus 500 may also include an indicate logic 522-4. Indicate logic 522-4 may be executed by circuitry 520 to indicate results of predicted behavior to facilitate resource allocation and scheduling for the workload supported by the data center. For these examples, the predicted behavior may be included in predicted behavior 530.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

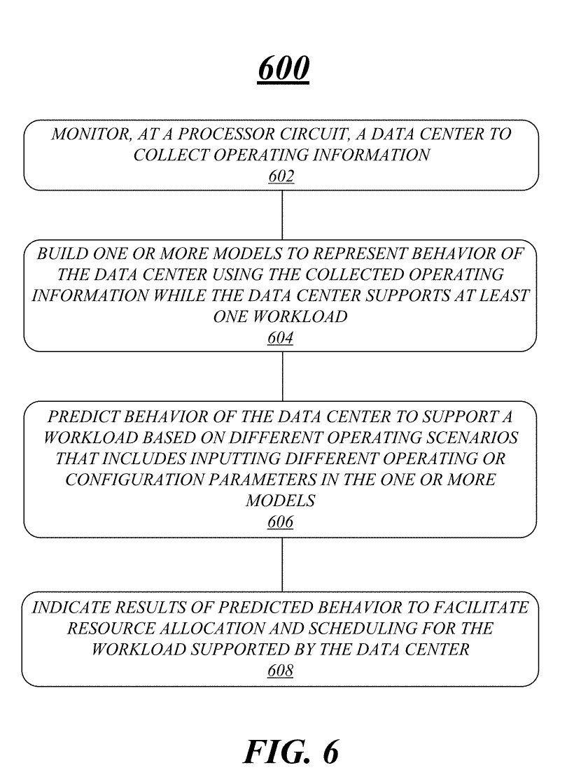

FIG. 6 illustrates an example of a logic flow. As shown in FIG. 6 the logic flow includes a logic flow 600. Logic flow 600 may be representative of some or all of the operations executed by one or more logic, features, or devices described herein, such as apparatus 600. More particularly, logic flow 600 may be implemented by at least monitor logic 522-1, model logic 522-2, predict logic 522-3 or indicate logic 522-4.

According to some examples, logic flow 600 at block 602 may monitor a data center to collect operating information. For these examples, monitor logic 522-1 may monitor the data center.

In some examples, logic flow 600 at block 604 may build one or more models to represent behavior of the data center using the collected operating information while the data center supports at least one workload. For these examples, model logic 522-2 may build the one or more models.

According to some examples, logic flow 600 at block 606 may predict behavior of the data center to support a workload based on different operating scenarios that includes inputting different operating or configuration parameters in the one or more models. For these examples, predict logic 522-3 may predict behavior of the data center using the one or more models built by model logic 522-1.

In some examples, logic flow 600 at block 608 may indicate results of predicted behavior to facilitate resource allocation and scheduling for the workload supported by the data center. For these examples, indicate logic 522-4 may indicate results of the predicted behavior.

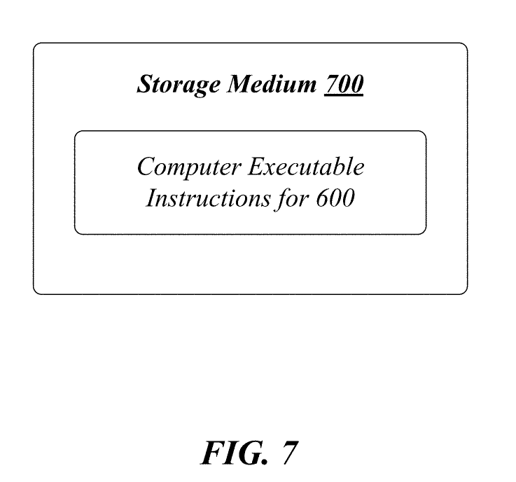

FIG. 7 illustrates an example of a storage medium 700. Storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions to implement logic flow 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

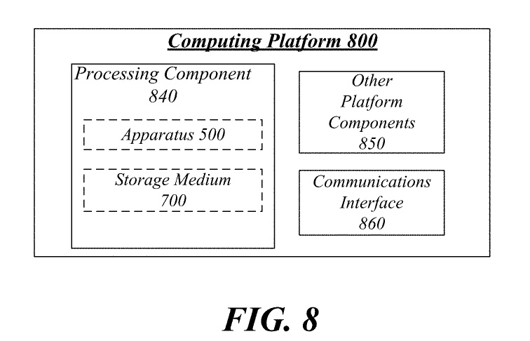

FIG. 8 illustrates an example computing platform 800. In some examples, as shown in FIG. 8, computing platform 800 may include a processing component 840, other platform components or a communications interface 860. According to some examples, computing platform 800 may be implemented in a computing device such as a server in a system such as a data center that may support and/or provide information (e.g., predicted behaviors) to a manager or management entities for configurable computing resources of a data center.

According to some examples, processing component 840 may execute processing operations or logic for apparatus 500 and/or storage medium 700. Processing component 840 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 850 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 860 may include logic and/or features to support a communication interface. For these examples, communications interface 860 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 800 may be part of a computing device that may be, for example, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 800 described herein, may be included or omitted in various embodiments of computing platform 800, as suitably desired.

The components and features of computing platform 800 may be implemented using any combination of discrete circuitry, ASICs, logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

### EXAMPLE 1

An example apparatus may include circuitry. The apparatus may also include a monitor logic for execution by the circuitry to monitor a data center to collect operating information. The apparatus may also include a model logic for execution by the circuitry to build one or more models to represent behavior of the data center using the collected operating information while the data center supports at least one workload. The apparatus may also include a predict logic for execution by the circuitry to predict behavior of the data center to support a workload based on different operating scenarios that includes input of different operating or configuration parameters in the one or more built models. The apparatus may also include an indicate logic for execution by the circuitry to indicate results of predicted behavior to facilitate resource allocation and scheduling for the workload supported by the data center.

### EXAMPLE 2

The apparatus of example 1, the model logic may determine a workload classification cluster via machine learning that includes application of clustering to collected operating information to determine the workload classification cluster. The predict logic may classify the workload based on the workload having a workload profile or type that falls within the workload classification cluster and select at least one of the one or more built models to predict behavior of the data center to support the workload based on the classifying of the workload.

### EXAMPLE 3

The apparatus of example 2, the workload type or profile may include one of a first workload type or profile that is processing or processor intensive, a second workload type or profile that is memory intensive, a third workload type or profile that is network switch intensive, a fourth workload type or profile that is storage intensive or a fifth workload type or profile that is a balanced workload type or profile that has relatively equal processor, memory, network switch and storage intensities.

### EXAMPLE 4

The apparatus of example 1, the different operating scenarios may include operating or configuration parameters to meet one or more of a QoS, an SLA or a RAS requirement.

### EXAMPLE 5

The apparatus of example 4, the indicated results of predicted behavior including at least one of an indication of performance characteristics, thermal characteristics, power characteristics, or reliability characteristics for separate operating points in order for the data center to meet the one or more QoS, SLA or RAS requirements.

### EXAMPLE 6

The apparatus of example 1, the monitor logic may monitor the data center to collect operating information comprises the monitor logic to collect operating information generated by node computing resources, data center infrastructure, a framework for using the node computing resources and the data center infrastructure, and one or more applications or software implemented by at least portions of the node computing resources, the data center infrastructure or the framework.

### EXAMPLE 7

The apparatus of example 6, the indicate logic may indicate the results of predicted behavior to a resource orchestrator of the data center infrastructure, a resource manager of the framework, a job scheduler of the framework or a configuration manager of the framework.

### EXAMPLE 8

The apparatus of example 6, the monitored node computing resources may include one or more of a processor, a memory device, a storage device, a power module, a cooling module, a network input/output device, a network switch or a virtual machine.

### EXAMPLE 9

The apparatus of example 8, the monitored data center infrastructure may include separate groupings of node computing resources housed within one or more racks.

### EXAMPLE 10

The apparatus of example 6, the framework for using the node computing resources and the data center infrastructure may be a Spark framework.

### EXAMPLE 11

The apparatus of example 6, the one or more applications or software implemented by at least portions of the node computing resources, the data center infrastructure or the framework may include Internet web page search software, e-mail virus scan software, database software or streaming video content software, a genomics application or a cognitive compute application.

### EXAMPLE 12

The apparatus of example 1 may also include a digital display coupled to the circuitry to present a user interface view.

### EXAMPLE 13

An example method may include monitoring, at a processor circuit, a data center to collect operating information. The method may also include building one or more models to represent behavior of the data center using the collected operating information while the data center supports at least one workload. The method may also include predicting behavior of the data center to support a workload based on different operating scenarios that includes inputting different operating or configuration parameters in the one or more models. The method may also include indicating results of predicted behavior to facilitate resource allocation and scheduling for the workload supported by the data center.

### EXAMPLE 14

The method of example 13 may also include determining a workload classification cluster via machine learning that includes applying clustering to collected operating information to determine the workload classification cluster. The method may also include classifying the workload based on the workload having a workload profile or type that falls within the workload classification cluster. The method may also include selecting at least one of the built one or more models to predict behavior of the data center to support the workload based on the classifying of the workload.

### EXAMPLE 15

The method of example 14, the workload type or profile may include one of a first workload type or profile that is processing or processor intensive, a second workload type or profile that is memory intensive, a third workload type or profile that is network switch intensive, a fourth workload type or profile that is storage intensive or a fifth workload type or profile that is a balanced workload type or profile that has relatively equal processor, memory, network switch and storage intensities.

### EXAMPLE 16

The method of example 13, the different operating scenarios may include separate operating or configuration parameters to meet one or more of a QoS, an SLA or a RAS requirement.

### EXAMPLE 17

The method of example 16, the indicated results of predicted behavior may include at least one of an indication of performance characteristics, thermal characteristics, power characteristics, or reliability characteristics for separate operating points in order for the data center to meet the one or more QoS, SLA or RAS requirements.

### EXAMPLE 18

The method of example 13, monitoring the data center to collect operating information may include collecting operating information generated by node computing resources, data center infrastructure, a framework for using the node computing resources and the data center infrastructure, and one or more applications or software implemented by at least portions of the node computing resources, the data center infrastructure or the framework.

### EXAMPLE 19

The method of example 18, indicating the results of predicted behavior to a resource orchestrator of the data center infrastructure, a resource manager of the framework, a job scheduler of the framework or a configuration manager of the framework.

### EXAMPLE 20

The method of example 18, the monitored node computing resources including one or more of a processor, a memory device, a storage device, a power module, a cooling module, a network input/output device, a network switch or a virtual machine.

### EXAMPLE 21

The method of example 20, the monitored data center infrastructure may include separate groupings of node computing resources housed within one or more racks.

### EXAMPLE 22

The method of example 18, the framework for using the node computing resources and the data center infrastructure may be a Spark framework.

### EXAMPLE 23

The method of example 18, the one or more applications or software implemented by at least portions of the node computing resources, the data center infrastructure or the framework may include Internet web page search software, e-mail virus scan software, database software or streaming video content software, a genomics application or a cognitive compute application.

### EXAMPLE 24

An example at least one machine readable medium may include a plurality of instructions that in response to being executed by a system cause the system to carry out a method according to any one of examples 13 to 23.

### EXAMPLE 25

An example apparatus may include means for performing the methods of any one of examples 13 to 23.

### EXAMPLE 26

An example at least one machine readable medium may include a plurality of instructions that in response to being executed by a system may cause the system to monitor a data center to collect operating information. The instructions may also cause the system to build one or more models to represent behavior of the data center using the collected operating information while supporting at least one workload. The instructions may also cause the system to predict behavior of the data center to support a workload based on different operating scenarios that includes inputting different operating or configuration parameters in the one or more models. The instructions may also cause the system to indicate results of predicted behavior to facilitate resource allocation and scheduling for the workload supported by the data center.

### EXAMPLE 27

The at least one machine readable medium of example 26, the instructions may further cause the system to determine a workload classification cluster via machine learning that includes applying clustering to collected operating information to determine the workload classification cluster. The instructions may also cause the system to classify the workload based on the workload having a workload profile or type that falls within the workload classification cluster. The instructions may also cause the system to select at least one of the built one or more models to predict behavior of the data center to support the workload based on the classifying of the workload.

### EXAMPLE 28

The at least one machine readable medium of example 27, the workload type or profile may include one of a first workload type or profile that is processing or processor intensive, a second workload type or profile that is memory intensive, a third workload type or profile that is network switch intensive, a fourth workload type or profile that is storage intensive or a fifth workload type or profile that is a balanced workload type or profile that has relatively equal processor, memory, network switch and storage intensities.

### EXAMPLE 29

The at least one machine readable medium of example 26, the different operating scenarios may include operating or configuration parameters to meet one or more of a QoS, an SLA or a RAS requirement.

### EXAMPLE 30

The at least one machine readable medium of example 29, the indicated results of predicted behavior may include at least one of an indication of performance characteristics, thermal characteristics, power characteristics, or reliability characteristics for separate operating points in order for the data center to meet the one or more QoS, SLA or RAS requirements.

### EXAMPLE 31

The at least one machine readable medium of example 26, the instructions to cause the system to monitor the data center to collect operating information may include the system to collect operating information generated by node computing resources, data center infrastructure, a framework for using the node computing resources and the data center infrastructure, and one or more applications or software implemented by at least portions of the node computing resources, the data center infrastructure or the framework.

### EXAMPLE 32

The at least one machine readable medium of example 31, the instructions may cause the system to indicate results of predicted behavior to a resource orchestrator of the data center infrastructure, a resource manager of the framework, a job scheduler of the framework or a configuration manager of the framework.

### EXAMPLE 33

The at least one machine readable medium of example 31, the monitored node computing resources may include one or more of a processor, a memory device, a storage device, a power module, a cooling module, a network input/output device, a network switch or a virtual machine.

### EXAMPLE 34

The at least one machine readable medium of example 33, the monitored data center infrastructure may include separate groupings of node computing resources housed within one or more racks.

### EXAMPLE 35

The at least one machine readable medium of example 31, the framework for using the node computing resources and the data center infrastructure may be a Spark framework.

### EXAMPLE 36

The at least one machine readable medium of example 31, the one or more applications or software implemented by at least portions of the node computing resources, the data center infrastructure or the framework may include Internet web page search software, e-mail virus scan software, database software or streaming video content software, a genomics application or a cognitive compute application.

### EXAMPLE 37

A method comprising: monitoring, at a processor circuit communicatively coupled to a data center, the data center to collect operating information of the data center; building one or more models to represent behavior of the data center while the data center supports at least one workload based on the collected operating information; predicting behavior of the data center to support a first workload based on different operating scenarios that includes inputting different operating or configuration parameters in the one or more models; and indicating results of predicted behavior to facilitate resource allocation and scheduling for the first workload.

### EXAMPLE 38

The method of claim 37, comprising: clustering the collected operating information; and determining a workload classification cluster based on clustering the collected operating information; determining a workload profile or workload type of the first workload; classifying the first workload based in part of the determined workload profile or type and the determined workload classification cluster; and selecting at least one of the built one or more models to predict behavior of the data center to support the first workload based on the classifying of the first workload.

### EXAMPLE 39

The method of claim 37, the different operating scenarios comprising separate operating or configuration parameters to meet one or more of a quality of service (QoS) requirement, a service level agreement (SLA) requirement or a reliability, availability and serviceability (RAS) requirement.

### EXAMPLE 40

The method of claim 39, the indicated results of predicted behavior including at least one of an indication of performance characteristics, thermal characteristics, power characteristics, or reliability characteristics for separate operating points, the separate operating points including an indication of one or more QoS, SLA or RAS requirements.

### EXAMPLE 41

At least one machine readable medium comprising a plurality of instructions that in response to being executed by a system causes the system to: monitor a data center to collect operating information of the data center; build one or more models to represent behavior of the data center while the data center supports at least one workload based on the collected operating information; predict behavior of the data center to support a first workload based on different operating scenarios that includes inputting different operating or configuration parameters in the one or more models; and indicate results of predicted behavior to facilitate resource allocation and scheduling for the first workload.

### EXAMPLE 42

The at least one machine readable medium of claim 41, comprising the instructions to further cause the system to: cluster the collected operating information; determine a workload classification cluster based on clustering the collected operating information; determine a workload profile or workload type of the first workload; classify the first workload based in part on the determined workload profile or type and the determined workload classification cluster; and select at least one of the built one or more models to predict behavior of the data center to support the first workload based on the classifying of the workload.

### EXAMPLE 43

The at least one machine readable medium of claim 41, the different operating scenarios comprising operating or configuration parameters to meet one or more of a quality of service (QoS) requirement, a service level agreement (SLA) requirement or a reliability, availability and serviceability (RAS) requirement.

### EXAMPLE 44

The at least one machine readable medium of claim 43, the indicated results of predicted behavior including at least one of an indication of performance characteristics, thermal characteristics, power characteristics, or reliability characteristics for separate operating points in order for the data center to meet the one or more QoS, SLA or RAS requirements.

### EXAMPLE 45

The at least one machine readable medium of claim 41, comprising instructions to cause the system collect operating information generated by node computing resources, data center infrastructure, a framework for using the node computing resources and the data center infrastructure, and one or more applications or software implemented by at least portions of the node computing resources, the data center infrastructure or the framework.

### EXAMPLE 46

The at least one machine readable medium of claim 45, comprising instructions to cause the system to indicate results of predicted behavior to a resource orchestrator of the data center infrastructure, a resource manager of the framework, a job scheduler of the framework or a configuration manager of the framework.

### EXAMPLE 47

The at least one machine readable medium of claim 44, the node computing resources comprising one or more of a processor, a memory device, a storage device, a power module, a cooling module, a network input/output device, a network switch or a virtual machine.

### EXAMPLE 48

The at least one machine readable medium of claim 47, the data center infrastructure comprising separate groupings of node computing resources housed within one or more racks.

### EXAMPLE 49

The at least one machine readable medium of claim 44, the one or more applications or software implemented by at least portions of the node computing resources, the data center infrastructure or the framework comprises Internet web page search software, e-mail virus scan software, database software or streaming video content software, a genomics application or a cognitive compute application.

### EXAMPLE 50

An apparatus comprising: circuitry communicatively coupled to a data center: a monitor for execution by the circuitry to monitor the data center to collect operating information of the data center; a modeler for execution by the circuitry to build one or more models to represent behavior of the data center while the data center supports at least one workload based on the collected information; a predictor for execution by the circuitry to predict behavior of the data center to support a first workload based on different operating scenarios that includes input of different operating or configuration parameters in the one or more built models; and an indicate logic for execution by the circuitry to indicate results of predicted behavior to facilitate resource allocation and scheduling for the first workload.

### EXAMPLE 51

The apparatus of claim 1, the modeler to cluster the collected operating information and determine a workload classification cluster based on the clustering collected operating information; and the predictor to determine a workload profile or workload type of the first workload, classify the workload based in part on the determined workload profile or type and the determined workload classification, and select at least one of the one or more built models to predict behavior of the data center to support the first workload based on the classifying of the workload.

### EXAMPLE 52

The apparatus of claim 51, the workload type or profile comprising one of a first workload type or profile that is processing or processor intensive, a second workload type or profile that is memory intensive, a third workload type or profile that is network switch intensive, a fourth workload type or profile that is storage intensive or a fifth workload type or profile that is a balanced workload type or profile that has relatively equal processor, memory, network switch and storage intensities.

### EXAMPLE 53

The apparatus of claim 50, the different operating scenarios comprising operating or configuration parameters to meet one or more of a quality of service (QoS) requirement, a service level agreement (SLA) requirement or a reliability, availability and serviceability (RAS) requirement.

### EXAMPLE 54

The apparatus of claim 53, the indicated results of predicted behavior including at least one of an indication of performance characteristics, thermal characteristics, power characteristics, or reliability characteristics for separate operating points in order for the data center to meet the one or more QoS, SLA or RAS requirements.

### EXAMPLE 55

The apparatus of claim 50, the monitor to monitor the data center to collect operating information generated by node computing resources, data center infrastructure, a framework for using the node computing resources and the data center infrastructure, and one or more applications or software implemented by at least portions of the node computing resources, the data center infrastructure or the framework.

### EXAMPLE 56

The apparatus of claim 55, the indicator to indicate the results of predicted behavior to a resource orchestrator of the data center infrastructure, a resource manager of the framework, a job scheduler of the framework or a configuration manager of the framework.

### EXAMPLE 57

The apparatus of claim 55, the monitored node computing resources comprising one or more of a processor, a memory device, a storage device, a power module, a cooling module, a network input/output device, a network switch or a virtual machine.

### EXAMPLE 58

The apparatus of claim 57, the monitored data center infrastructure comprising separate groupings of node computing resources housed within one or more racks.

### EXAMPLE 59

The apparatus of claim 55, the framework for using the node computing resources and the data center infrastructure comprises a Spark framework.

### EXAMPLE 60

The apparatus of claim 55, the one or more applications or software implemented by at least portions of the node computing resources, the data center infrastructure or the framework comprises Internet web page search software, e-mail virus scan software, database software or streaming video content software, a genomics application or a cognitive compute application.

### EXAMPLE 61

The apparatus of claim 50, comprising a digital display coupled to the circuitry to present a user interface view.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
circuitry communicatively coupled to a data center:
a monitor for execution by the circuitry to monitor the data center to collect operating information of the data center while the data center supports at least one workload;
a modeler for execution by the circuitry to build one or more models to represent behavior of the data center based in part on the collected operating information;
a predictor for execution by the circuitry to predict behavior of the data center to support a workload based on different operating scenarios that includes input of different operating or configuration parameters in the one or more built models; and
an indicator for execution by the circuitry to indicate results of predicted behavior to facilitate resource allocation and scheduling for the workload supported by the data center.

2. The apparatus of claim 1, the modeler to cluster the collected operating information and determine a workload classification cluster based on the clustering collected operating information; and the predictor to determine a workload profile or workload type of the first workload, classify the workload based in part on the determined workload profile or type and the determined workload classification, and select at least one of the one or more built models to predict behavior of the data center to support the first workload based on the classifying of the workload.

3. The apparatus of claim 2, the workload type or profile comprising one of a first workload type or profile that is processing or processor intensive, a second workload type or profile that is memory intensive, a third workload type or profile that is network switch intensive, a fourth workload type or profile that is storage intensive or a fifth workload type or profile that is a balanced workload type or profile that has relatively equal processor, memory, network switch and storage intensities.

4. The apparatus of claim 1, the different operating scenarios comprising operating or configuration parameters to meet one or more of a quality of service (QoS) requirement, a service level agreement (SLA) requirement or a reliability, availability and serviceability (RAS) requirement.

5. The apparatus of claim 4, the indicated results of predicted behavior including at least one of an indication of performance characteristics, thermal characteristics, power characteristics, or reliability characteristics for separate operating points in order for the data center to meet the one or more QoS, SLA or RAS requirements.

6. The apparatus of claim 1, the monitor to monitor the data center to collect operating information generated by node computing resources, data center infrastructure, a framework for using the node computing resources and the data center infrastructure, and one or more applications or software implemented by at least portions of the node computing resources, the data center infrastructure or the framework.

7. The apparatus of claim 6, the indicator to indicate the results of predicted behavior to a resource orchestrator of the data center infrastructure, a resource manager of the framework, a job scheduler of the framework or a configuration manager of the framework.

8. The apparatus of claim 6, the monitored node computing resources comprising one or more of a processor, a memory device, a storage device, a power module, a cooling module, a network input/output device, a network switch or a virtual machine.

9. The apparatus of claim 8, the monitored data center infrastructure comprising separate groupings of node computing resources housed within one or more racks.

10. The apparatus of claim 6, the framework for using the node computing resources and the data center infrastructure comprising a Spark framework.

11. The apparatus of claim 6, the one or more applications or software implemented by at least portions of the node computing resources, the data center infrastructure or the framework comprises Internet web page search software, e-mail virus scan software, database software or streaming video content software, a genomics application or a cognitive compute application.

12. The apparatus of claim 1, comprising a digital display coupled to the circuitry to present a user interface view.

13. A method comprising:
monitoring, at a processor circuit communicatively coupled to a data center, the data center to collect operating information of the data center;
building one or more models to represent behavior of the data center while the data center supports at least one workload based on the collected operating information;
predicting behavior of the data center to support a first workload based on different operating scenarios that includes inputting different operating or configuration parameters in the one or more models; and
indicating results of predicted behavior to facilitate resource allocation and scheduling for the first workload.

14. The method of claim 13, comprising:
clustering the collected operating information; and
determining a workload classification cluster based on clustering the collected operating information;
determining a workload profile or workload type of the first workload;
classifying the first workload based in part of the determined workload profile or type and the determined workload classification cluster; and
selecting at least one of the built one or more models to predict behavior of the data center to support the first workload based on the classifying of the first workload.

15. The method of claim 13, the different operating scenarios comprising separate operating or configuration parameters to meet one or more of a quality of service (QoS) requirement, a service level agreement (SLA) requirement or a reliability, availability and serviceability (RAS) requirement.

16. The method of claim 15, the indicated results of predicted behavior including at least one of an indication of performance characteristics, thermal characteristics, power characteristics, or reliability characteristics for separate operating points, the separate operating points including an indication of one or more QoS, SLA or RAS requirements.

17. At least one machine readable medium comprising a plurality of instructions that in response to being executed by a system causes the system to:
monitor a data center to collect operating information of the data center;
build one or more models to represent behavior of the data center while the data center supports at least one workload based on the collected operating information;
predict behavior of the data center to support a first workload based on different operating scenarios that includes inputting different operating or configuration parameters in the one or more models; and
indicate results of predicted behavior to facilitate resource allocation and scheduling for the first workload.

18. The at least one machine readable medium of claim 17, comprising the instructions to further cause the system to:
cluster the collected operating information;
determine a workload classification cluster based on clustering the collected operating information;
determine a workload profile or workload type of the first workload;
classify the first workload based in part on the determined workload profile or type and the determined workload classification cluster; and
select at least one of the built one or more models to predict behavior of the data center to support the first workload based on the classifying of the workload.

19. The at least one machine readable medium of claim 17, the different operating scenarios comprising operating or configuration parameters to meet one or more of a quality of service (QoS) requirement, a service level agreement (SLA) requirement or a reliability, availability and serviceability (RAS) requirement.

20. The at least one machine readable medium of claim 19, the indicated results of predicted behavior including at least one of an indication of performance characteristics, thermal characteristics, power characteristics, or reliability characteristics for separate operating points in order for the data center to meet the one or more QoS, SLA or RAS requirements.

21. The at least one machine readable medium of claim 17, comprising instructions to cause the system collect operating information generated by node computing resources, data center infrastructure, a framework for using the node computing resources and the data center infrastructure, and one or more applications or software implemented by at least portions of the node computing resources, the data center infrastructure or the framework.

22. The at least one machine readable medium of claim 21, comprising instructions to cause the system to indicate results of predicted behavior to a resource orchestrator of the data center infrastructure, a resource manager of the framework, a job scheduler of the framework or a configuration manager of the framework.

23. The at least one machine readable medium of claim 20, the node computing resources comprising one or more of a processor, a memory device, a storage device, a power module, a cooling module, a network input/output device, a network switch or a virtual machine.

24. The at least one machine readable medium of claim 23, the data center infrastructure comprising separate groupings of node computing resources housed within one or more racks.

25. The at least one machine readable medium of claim 20, the one or more applications or software implemented by at least portions of the node computing resources, the data center infrastructure or the framework comprises Internet web page search software, e-mail virus scan software, database software or streaming video content software, a genomics application or a cognitive compute application.
